(19) United States
(12) Patent Application Publication
(10) Pub. No.: US 2022/0297591 A1
(43) Pub. Date: Sep. 22, 2022

(54) Cargo tie-down assisting apparatus

(71) Applicant: Douglas R. Brown, Hamilton (CA)

(72) Inventor: Douglas R. Brown, Hamilton (CA)

(21) Appl. No.: 17/803,247

(22) Filed: Apr. 1, 2022

Related U.S. Application Data
(60) Provisional application No. 63/258,509, filed on May 10, 2021.

(30) Foreign Application Priority Data
Mar. 1, 2021 (CA) 3110304

(51) Int. Cl. B60P 7/08

(52) U.S. Cl. CPC B60P 7/0853

(57) ABSTRACT

A flatbed rolling tarp system is a tarp covered structure that retracts and rolls from front to rear and rear to front or a track that is installed on a flatbed trailer. It's only purpose is to cover cargo. My innovation is to integrate pulleys and related components with main bow(s) enabling driver/operator (using ropes from the ground) to pull tie-downs from one side of system, up and over pulleys then release them on opposite side of system.

Pulleys will be swivelable, removable, relocatable, and lockable.

### (I) BACKGROUND OF THE INVENTION

### Field of the Invention—Flatbed Rolling Tarp Industry

My innovation will assist driver/operators in various stages of the tie-down process of cargo.

My innovation will save time during tie-down process of cargo, and reduce driver/operator physical exertion.

### (2) BRIEF SUMMARY OF THE INTENTION

A flatbed rolling tarp system is a tarp covered, retractable structure that rolls from front to rear and rear to front on a track. It's a only purpose is to cover cargo.

The system must be installed to a flatbed trailer to function as intended.

My innovation is to, give flatbed rolling tarp systems a new use to assist in various stages of the tie-down process of cargo. This is accomplished by integrating pulleys and related components with main bow(s) of flatbed rolling tarp systems with the purpose of pulling cargo tie-downs (straps, chains, ropes, cables, etc.) from one side of system, up and over pulleys then release them om opposite side of system.

Pulleys will be swivelable, removable, relocatable, and lockable. Driver/operator can operate system from the ground while standing in one spot.

### (3) BRIEF DESCRIPTION OF THE DRAWINGS

FIG. I Depicts side view of a retracted flatbed rolling tarp system that has been installed on a flatbed trailer showing drivers side axle with pulleys in open position with primary pull rope draped over pulleys, and lock/release mechanism hooked to tie-down component (chain) with cargo strap.

FIG. 2 Depicts perspective view of main bow integrated with pulleys showing arrangement of pulleys and ropes with lock/release mechanism. View also shows push rod secured to bow.

FIG. 3 Depicts perspective view of cargo strap with tie-down component (chain) that has been pulled from drivers side of system, then up and over pulleys to stop on passenger side of system, ready to be released.

FIG. 4 Depicts perspective view of cargo strap with tie-down component (chain) that has been released and dropped on passenger side off system.

FIG. 5 Depicts perspective view of cargo strap covering cargo. One end of cargo strap was released from lock/release mechanism, and other end of cargo strap was released by using push rod to lift cargo strap off main load pulley and drop it on cargo.

FIG. 6 Depicts side view of flatbed trailer with flatbed rolling tarp system with integrated bow and pulley apparatus.

FIG. 7a Depicts side view of inside of bow with drivers side pulley assembly secured to bow with pulleys locked in open position with swivel and locking ropes freely hanging.

FIG. 7b Depicts side view of pulley assembly locked in closed position with swivel and locking ropes loosely secured to hooks. View also shows mounting bracket secured near middle of bow.

FIG. 8a Depicts side view of inside of bow with passenger side pulley assembly secured to bow with pulley locked in open position with swivel and locking ropes freely hanging. View also shows push rod and primary pull rope with counter-weight rubber ball and lock/release mechanism secured to bow.

FIG. 8b Depicts side view of pulley assembly locked in closed position with swivel and locking ropes loosely secured to hooks. View also shows mounting bracket secured near middle of bow.

FIG. 9 Depicts exploded view of drivers side pulley assembly comprising drivers side mounting bracket, drivers side axle swivel tube component and drivers side axle with pulleys.

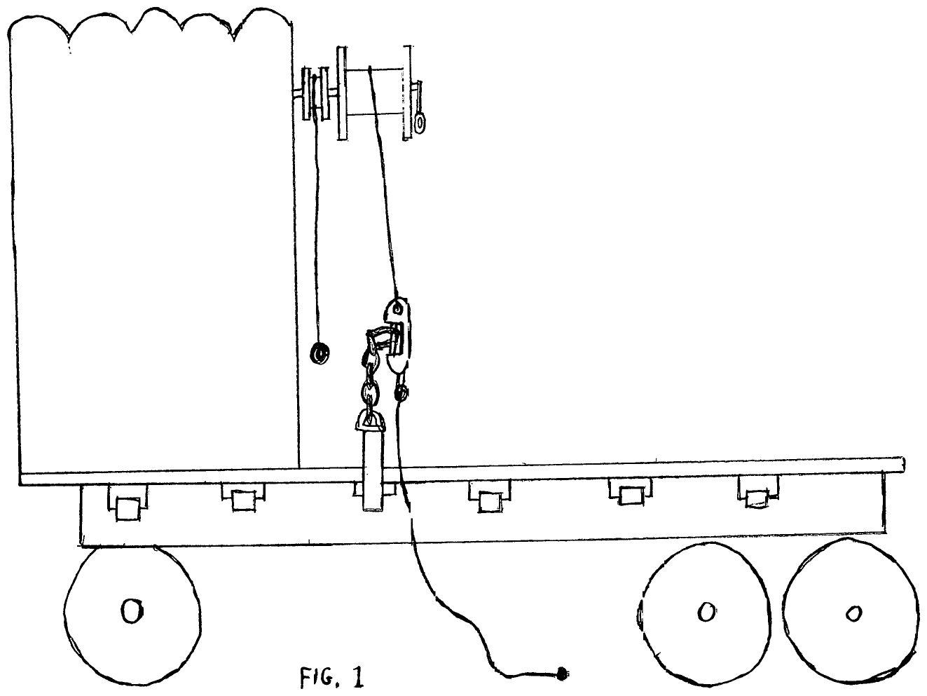

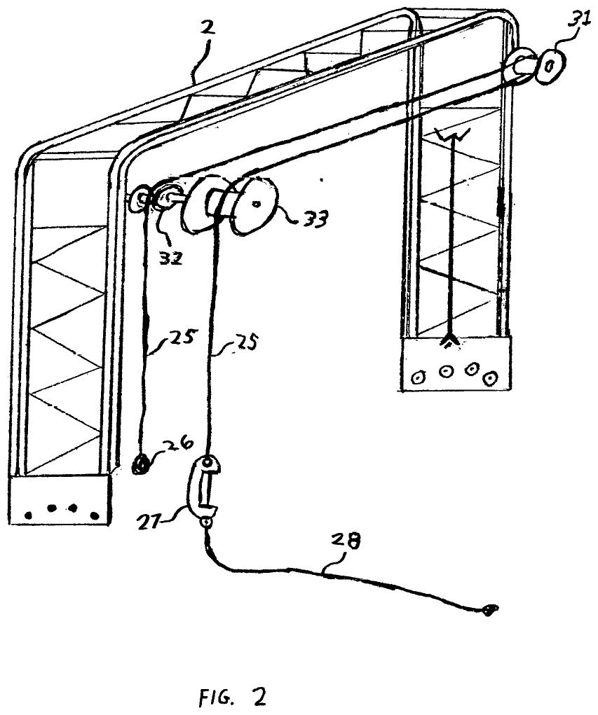

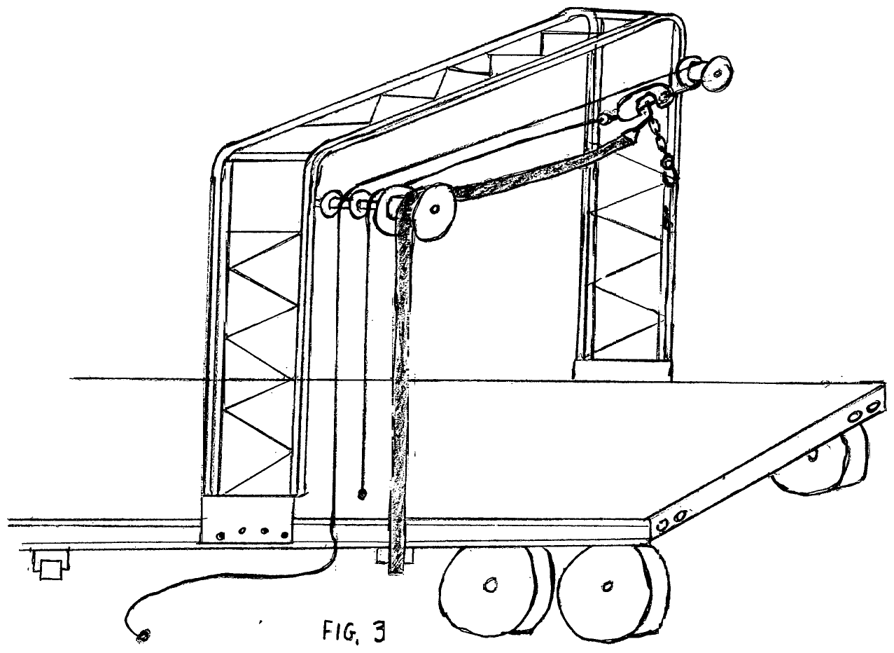

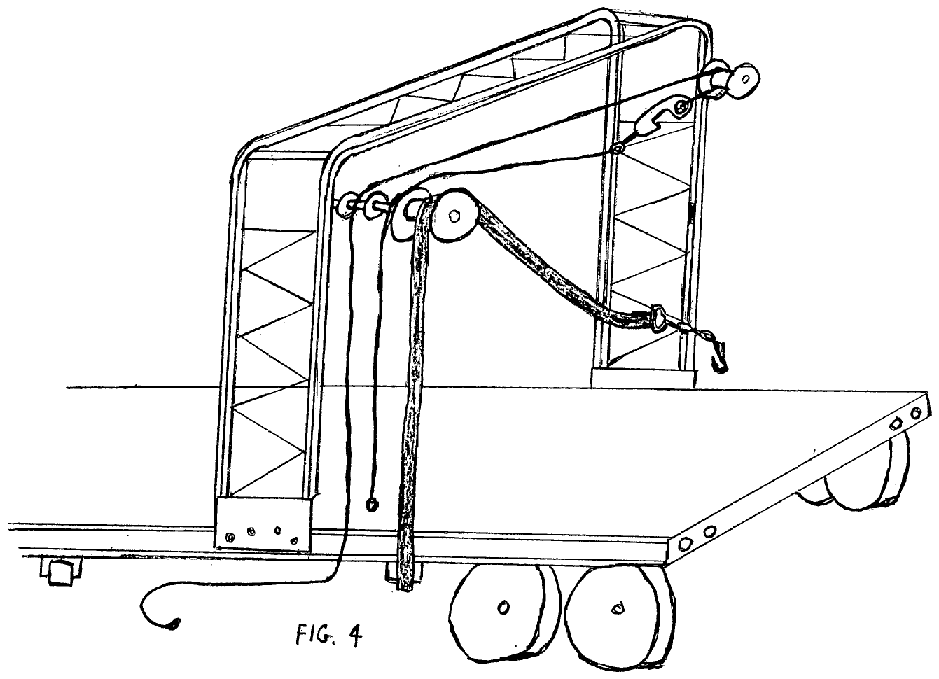

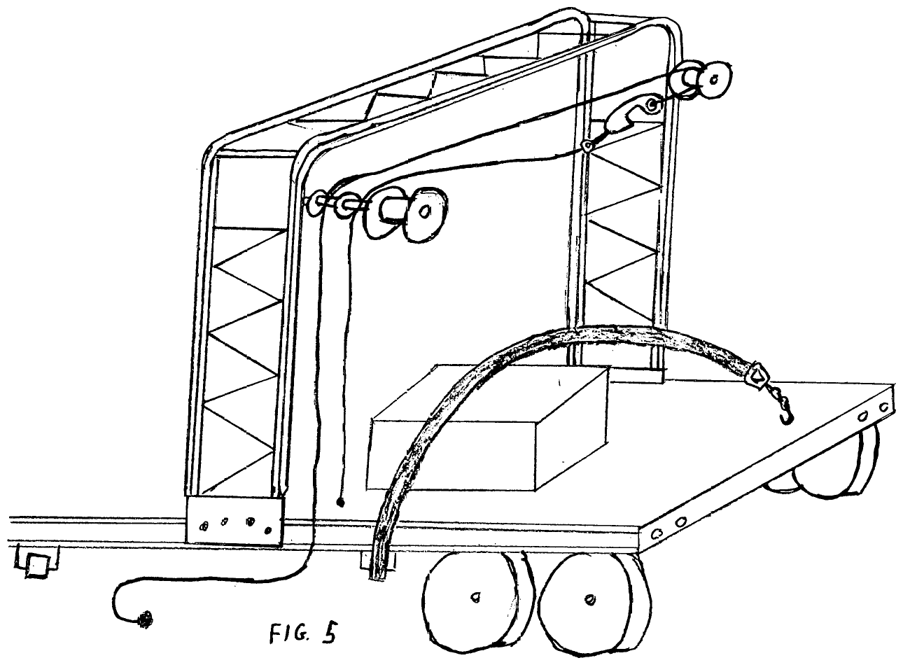

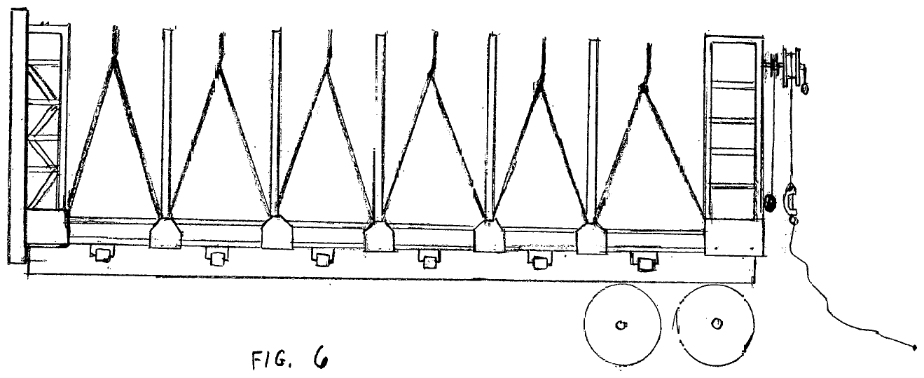

FIG. I0 Depicts exploded view of passenger side pulley assembly comprising passenger side mounting bracket, passenger sidle axle swivel tube component and passenger side axle with pulley.

FIG. IIa Depicts front view of lock/release mechanism securing tie-down component (chain) attached to cargo strap.

FIG. IIb Depicts front view of lock/release mechanism releasing tie-down component (chain) attached to cargo strap.

FIG. I2 Depicts front view of push rod used to install and remove pulley ropes.

FIG. I3 Depicts perspective view of primary pull rope with with counter-weight rubber ball and lock/release mechanism secured to ends of rope.

FIG. I4 Depicts perspective view of release rope with snap hook secured to release end of lock/release mechanism.

FIG. I5 Depicts perspective view of locking pliers with rope and magnet. Pliers stop main bow in front of strap and winch while magnet holds winch locking gear open.

FIG. I6 Depicts locking pliers with rope and magnet tethered together with locking pliers secured to trailer track to hold bow in alignment with trailer winch, while magnet holds winch locking gear open so cargo straps can freely move.

FIG. I7 Depicts rope being draped over passenger side pulley.

FIG. I8 Depicts rope being draped over drivers side pulleys.

FIG. I9 Depicts cargo strap being lifted off drivers side pulley.

### Variations

FIG. 20a Variation I Depicts front: view of foldidng pulley assembly secured to horizontal structure of main bow.

FIG. 20b Variation I Depicts top view of pulley assembly in closed position.

FIG. 20c Variation I Depicts top view of pulley assembly in open position.

FIG. 21a Variation 2 Depicts front view of fixed pulleys secured to horizontal structure of main bow.

FIG. 21b Variation 2 Depicts top view of fixed pulleys secured to horizontal structure of main bow.

FIG. 22a Variation 3 Depicts front view of fixed pulleys secured to vertical structure of main bow.

FIG. 22b Variation 3 Depicts top view of fixed pulleys secured to vertical structure of main bow.

FIG. 23a Variation 4 Depicts drivers side view of pulleys on removable pipe, secured to lower structure of main bow.

FIG. 23b Variation 4 Depicts passenger side view of pulley on removable pipe, secured to lower structure of main bow.

Note: Variations can be combined with each other including the preferred innovation.

### (4) DETAILED DESCRIPTION OF INVENTION

My innovation is to give flatbed rolling tarp systems a new use to assist in various stages of the tie-down process of cargo. This is accomplished by integrating pulleys and related components with main bow(s) of flatbed rolling tarp systems with the purpose of pulling cargo tie-downs (straps, chains, ropes, cables, etc.) from one side of system, up and over pulleys then release tie-downs on opposite side of system.

Pulleys will be swivelable, removable, relocatable and lockable. With ropes, spring bolts and a lock/release mechanism the system can be operated from the ground.

My innovation is for main bow(s) of flatbed rolling tarp systems but is only of practical use when installed on flatbed trailers, since nearly all flatbed trailers use cargo straps and winches my drawings will show innovation being used with cargo straps and winches but this in no way limits innovation to being used with cargo straps and winches. Innovation assists in moving tie-downs from one side of bow to opposite side of bow and releasing them. Tie-downs can be straps, chains, cables, ropes, etc. None of the tie-downs need to be directly attached to trailer in order for innovation to function as claimed.

Drawings show rear main bow but front main bow can also be used.

Mounting brackets will be made of welded steel but can be made of aluminum, high strength plastic or even carbon fiber and will be secured with bolts. Aluminum brackets could be welded. Pulleys will be made of high strength plastic but can be made of metals and even carbon fiber.

Nylon rope is preferred for its superior strength.

Push rod will be made of light gauge steel and pulley axles will be made of cold rolled steel or higher strength steel.

Fit and secure drivers side mounting brackets I to inside of vertical structure of drivers side rear and or front main bow 2 near middle and near top of bow 2 with bolts 3.

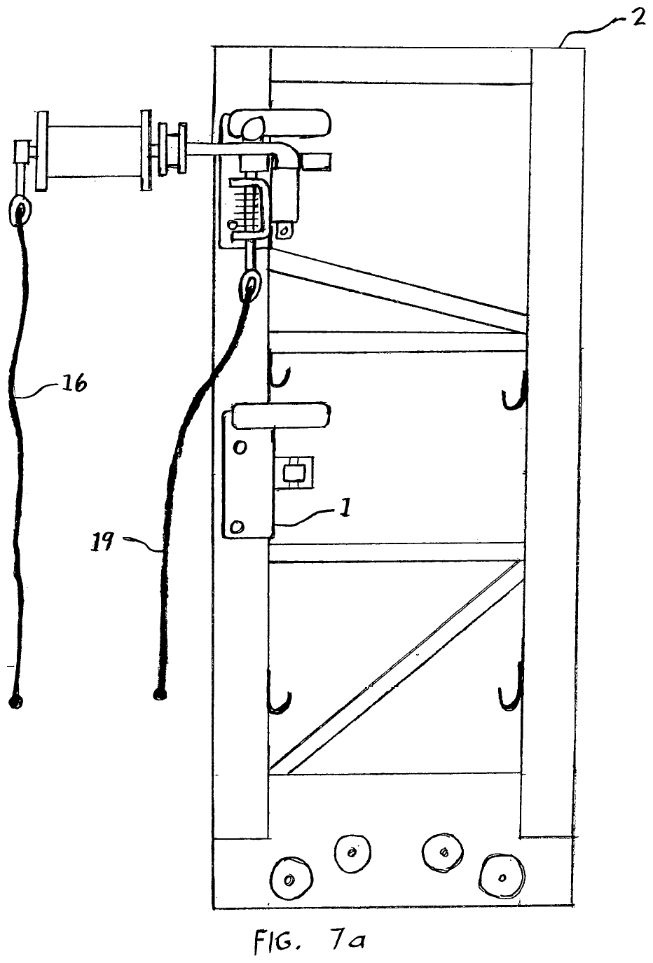

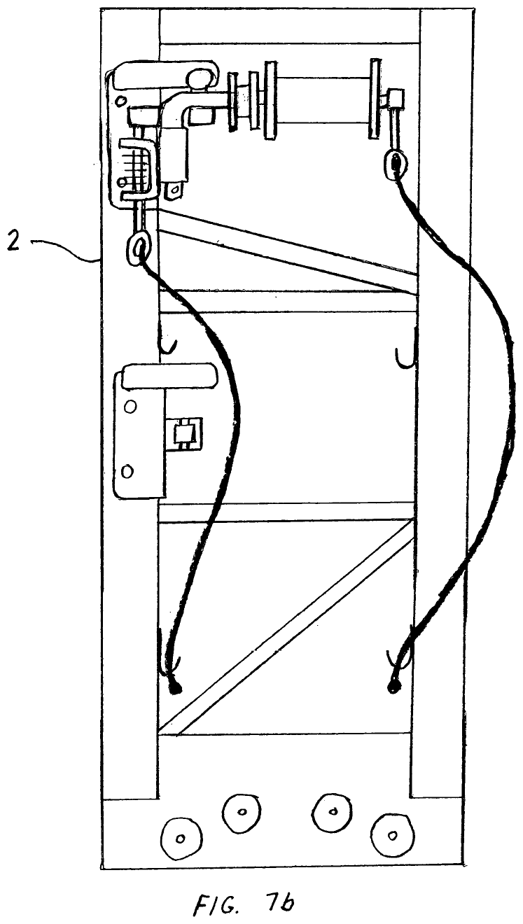

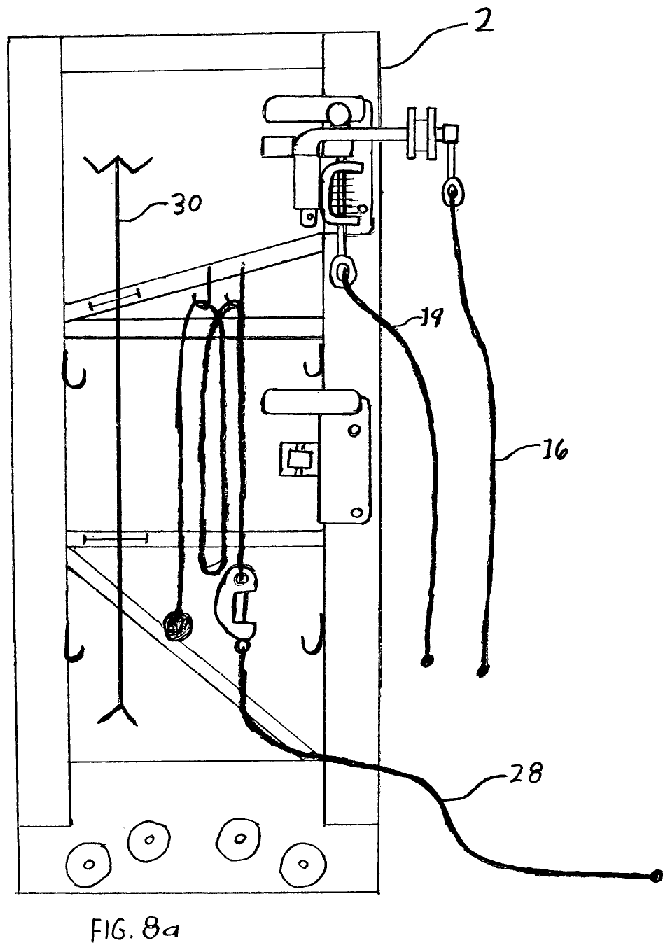

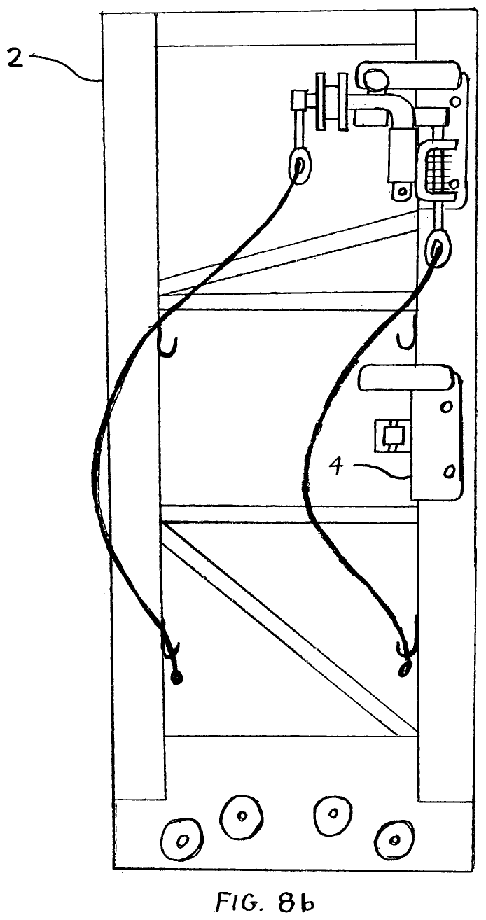

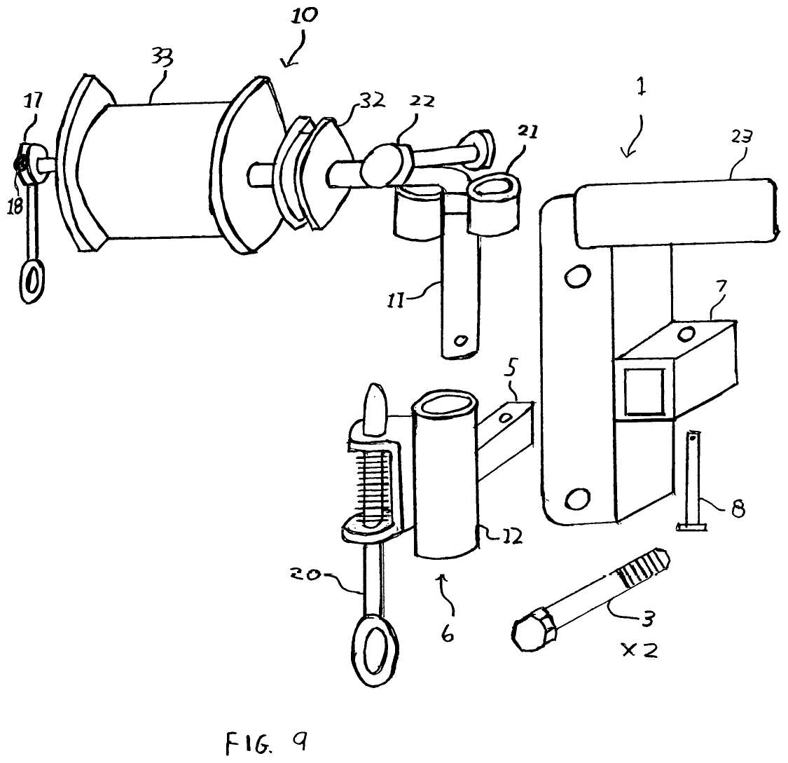

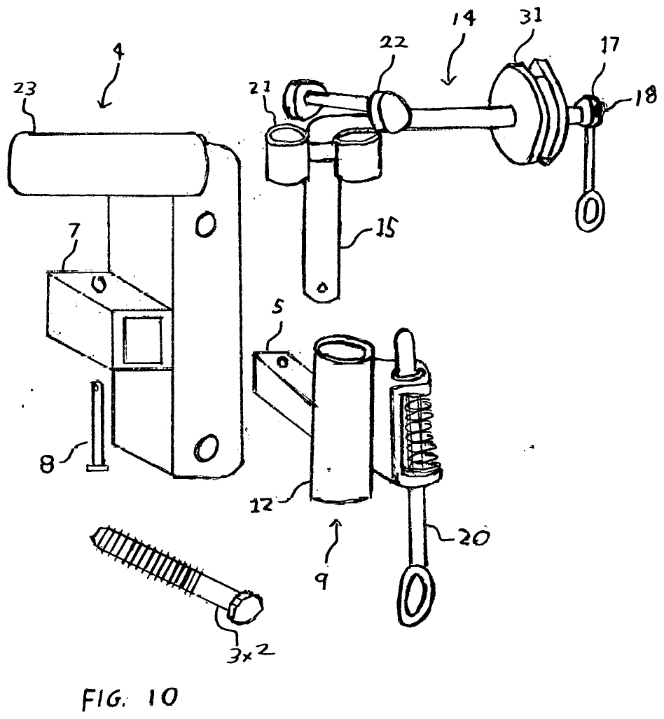

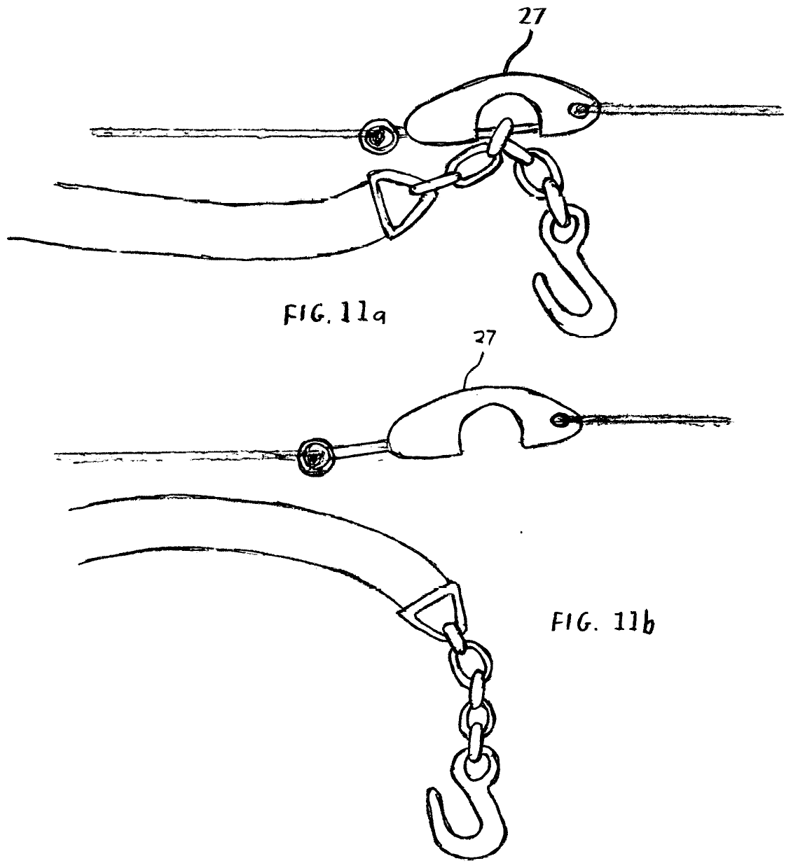

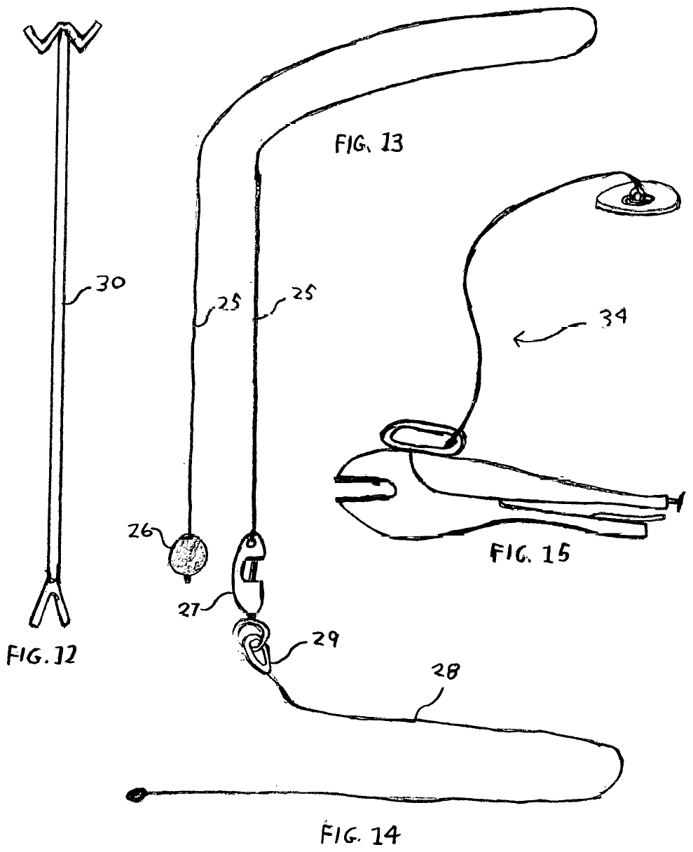

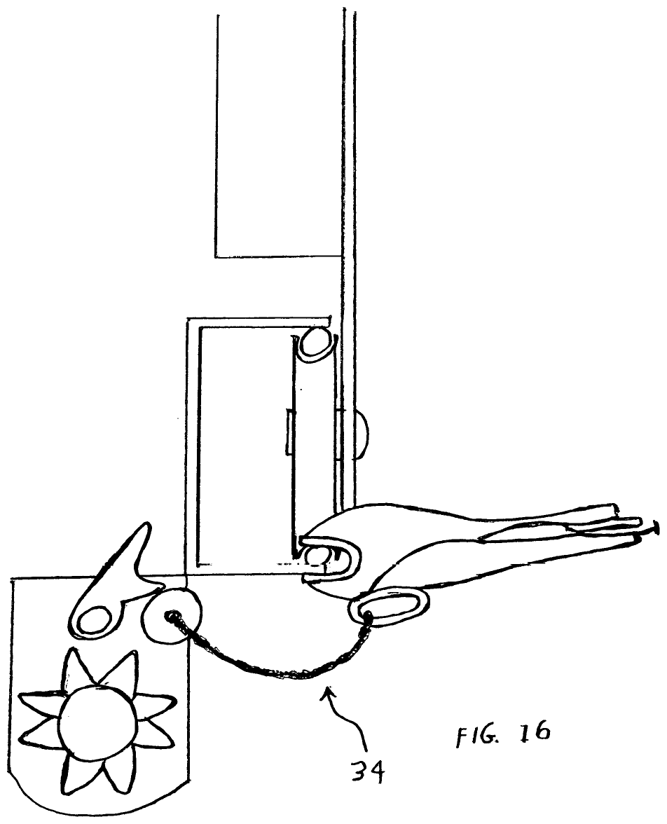

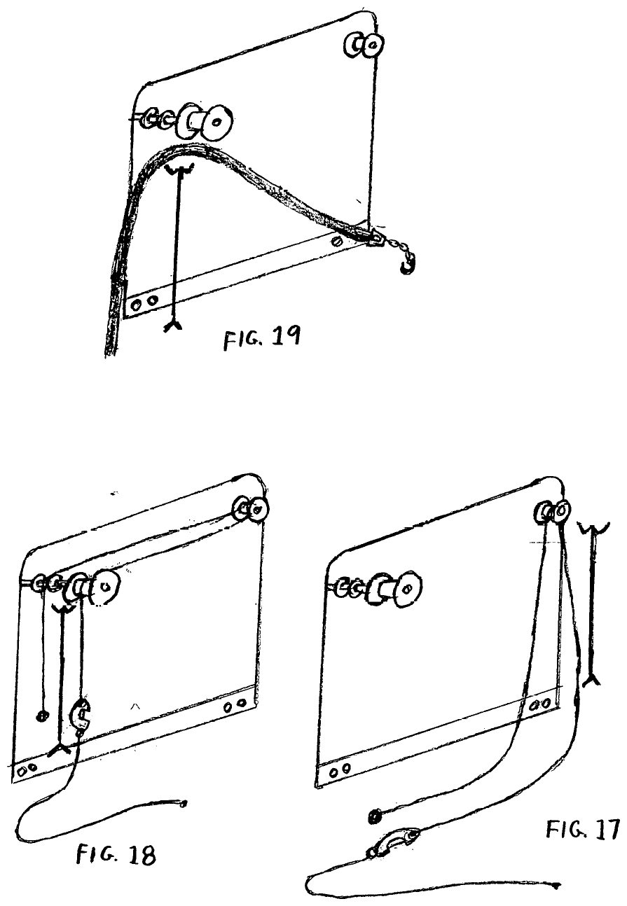

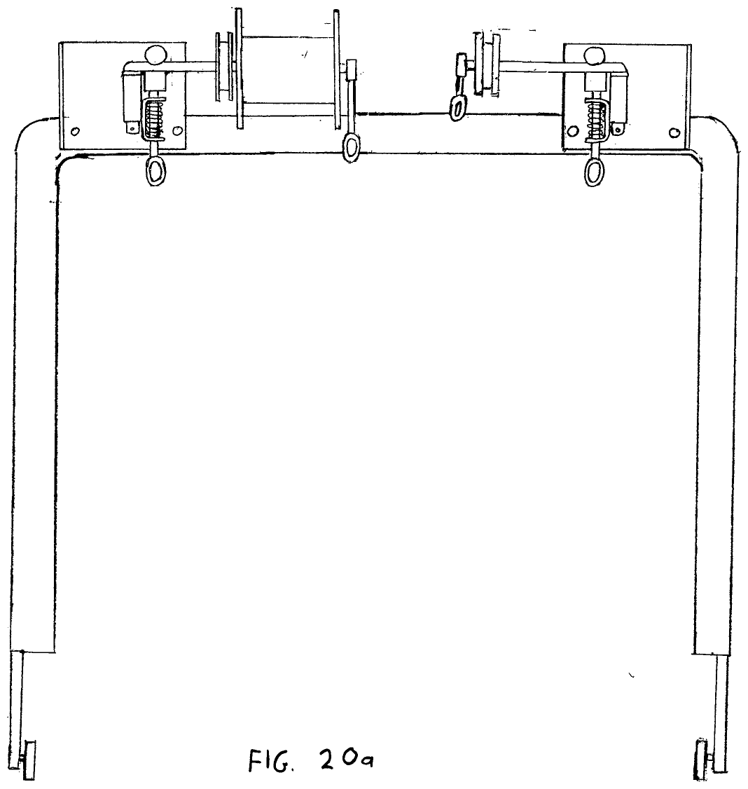

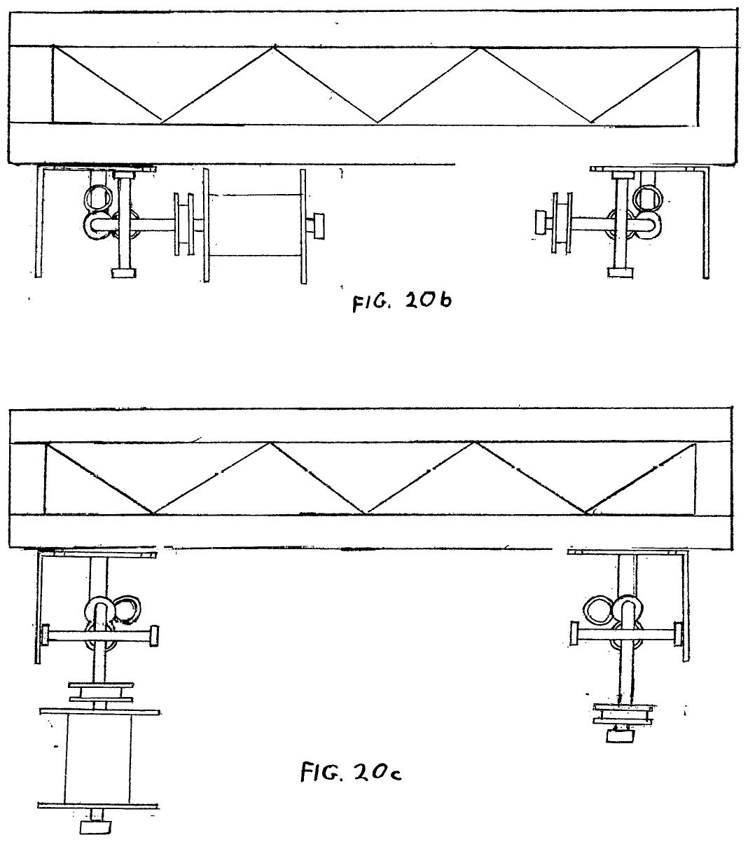

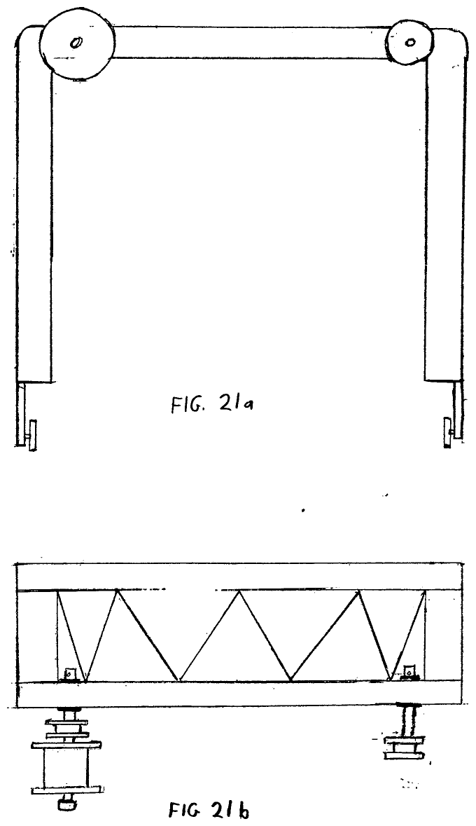

Fit and secure passenger side mounting brackets 4 to inside of vertical structure of passenger side rear and or front main bow 2 near middle and near top of bow 2 with bolts 3. Refer to FIG. 7a and FIG. 8a

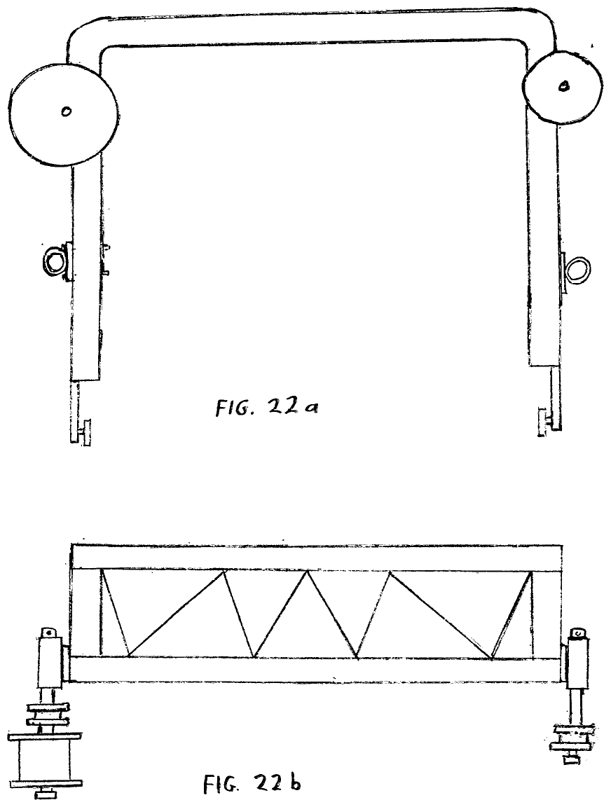

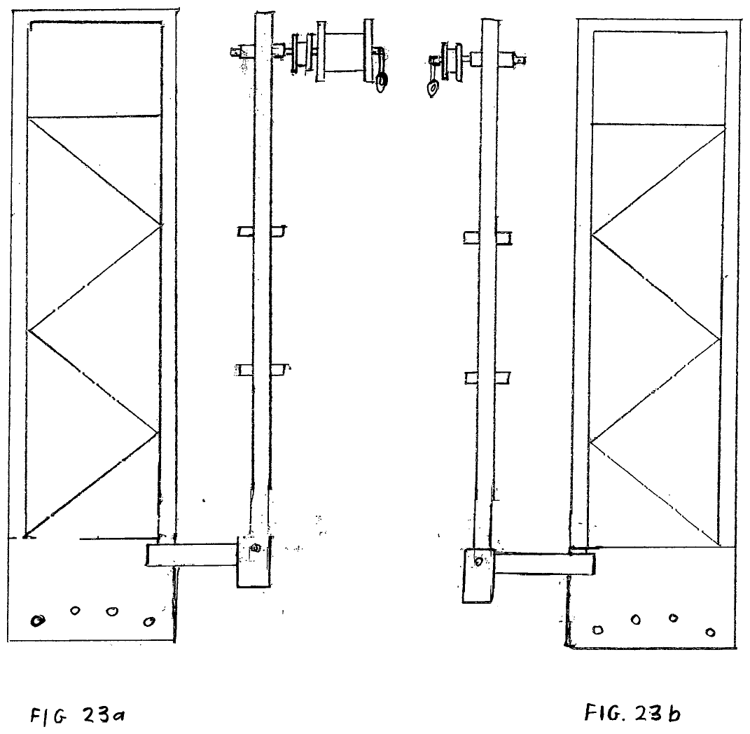

Next step refer to FIG. 9 Insert male fitting 5 of drivers side axle swivel tube component 6 into female fitting 7 of drivers side mounting bracket I and secure with pin 8.

Next step refer to FIG. I0 Insert male fitting 5 of passenger side axle swivel tube component 9, into female fitting 7 of passenger side mounting bracket 4 and secure with pin 8.

Next step refer to FIG. 9 Take drivers side axle with pulleys I0 and insert 90 degree bend end of axle II into drawers side swivel tube I2 and secure with pin I3.

Next step refer to FIG. I0 Take passenger side axle with pulley I4 and insert 90 degree bend end of axle I5 into passenger side swivel tube I2 and secure with pin I3.

When axles and pulleys are mounted to mounting brackets the axles with pulleys can swivel I80 degrees and lock/unlock for storage and for use.

Refer to FIG. 7a Pulleys can swivel by pulling and swinging swivel rope I6 that are secured to swivel rope attachments I7 that are secured to horizontal end of axles II and I5 by bolts I8.

Pulleys can lock/unlock for storage and for use by pulling locking rope I9 which is secured to spring bolt with rope attachment 20 which is welded to axle swivel tube components 6 and 9. Spring bolts with rope attachments lock into locking tubes 2I which are welded to axles II and I5.

To keep pulleys in proper alignment and make it easier to open/close lock/unlock from the ground stopper bolts 22 are welded to axles II and I5 and stopper plates 23 are welded to mounting bracket I and 4.

Next step, from the ground, and on passenger side of system, driver/operator pulley, holds, and swings swivel rope I6 while simultaneously pulling locking rope I9 that is attached to spring bolt with rope attachment 20. This unlocks spring bolt from locking tubes 2I which are welded to axles II and I5 and moves passenger side axle with pulley I4 I80 degrees from closed to open position. Releasing both ropes locks axle with pulley in open for use position.

Next the driver/operator walks to drivers side of system pulls, holds and swings swivel rope I6 while simultaneously pulling locking rope I9 that is attached to spring bolt with rope attachment 20. This unlocks spring bolt from locking tubes 2I which are welded to axles II and I5 and moves drivers aide axle and pulleys I0 I80 degrees from closed to open position. Releasing both ropes locks axle and pulleys in open for use position.

Now drivers side and passenger side pulleys are locked in open position and ready for use, but first you have to install ropes.

Primary pull rope 25 comprises counter-weight rubber ball 26 and lock/release mechanism 27 secured to ends of primary pull rope.

Release rope 28 comprises a snap hook 29 secured to end of release rope. Snap hook with release rope will be secured to release end of lock/release mechanism 27 shown in FIG. 9.

Now driver/operator uses push 30 and fits primary pull rope 25 in w-grooves on top end of push rod 30 and drapes primary pull rope 25 with attached release rope 28 over passenger side return pulley 31.

Now driver/operator with push rod 30 and primary pull rope 25 with release rope 28 walks to drivers side of trailer/system and drapes primary pull rope over drivers side drive pulley 32 and drivers side main lead pulley 33. Now ropes hang within easy reach from the grounds.

Next, driver/operator pushes rolling tarp system with bow 2 to winch location and holds bow with pulleys in alignment with winch and strap by using locking pliers with rope and magnet 34. Locking pliers clamp to track preventing bow from moving while magnet holds locking gear of winch open so cargo straps can move freely.

Next, driver/operator pulls cargo strap from winch and hooks tie-down component (chain) attached to cargo strap to lock of lock/release mechanism 27 then driver/operator pulls down on primary rope 25 which is, draped over drivers side drive pulley, This pulls up primary rope 25 which is draped over drivers side main load pulley and has the tie-down component (chain) attached to cargo strap and lock/release mechanism with release rope 28 and snap hook 29 secured to release end of lock/release mechanism. Driver/operator continues pulling rope and cargo strap with related parts up and over drivers side main load pulley until it stops just before touching passenger side return pulley, then driver/operator pulls release rope, releasing and dropping cargo strap on passenger side of bow/system/trailer. Driver/operator now uses push rod to remove cargo strap from drivers side main load pulley, letting it drop on cargo. Driver/operator can pull ropes back to original starting position and move bow to next strap and winch location.

The claimed invention is:

1. An apparatus to give new use to flatbed rolling tarp systems to assist in various stages of the tie-down process of cargo, comprising:
Bow(s) and apparatus integrated with each other.
